(19) United States
(12) Patent Application Publication
(10) Pub. No.: US 2012/0153672 A1
(43) Pub. Date: Jun. 21, 2012

(54) INTERIOR PANEL OF A VEHICLE

(76) Inventors: Jürgen Ackermann, Velbert (DE); Thomas Lohmann, Wesel (DE); Burkhard Schade, Bochum (DE); Ludwig Wehling, Borken (DE)

(21) Appl. No.: 12/968,545

(22) Filed: Dec. 15, 2010

(51) Int. Cl. B62D 25/02

(52) U.S. Cl. 296/191

(57) ABSTRACT

An interior panel of a vehicle, in particular a wall panel of a rail vehicle used in passenger transport, with fastenings and installation openings for mechanical, acoustic and/or electric functional or display elements is provided. Wall panels which are identical in each case are used at same installation sites of vehicles of a same kind, and an appropriately configured, standardized mounting element which is placed exchangeably onto the wall panel or is inserted into the wall panel is provided for receiving the mechanical, acoustic and/or electric functional or display elements.

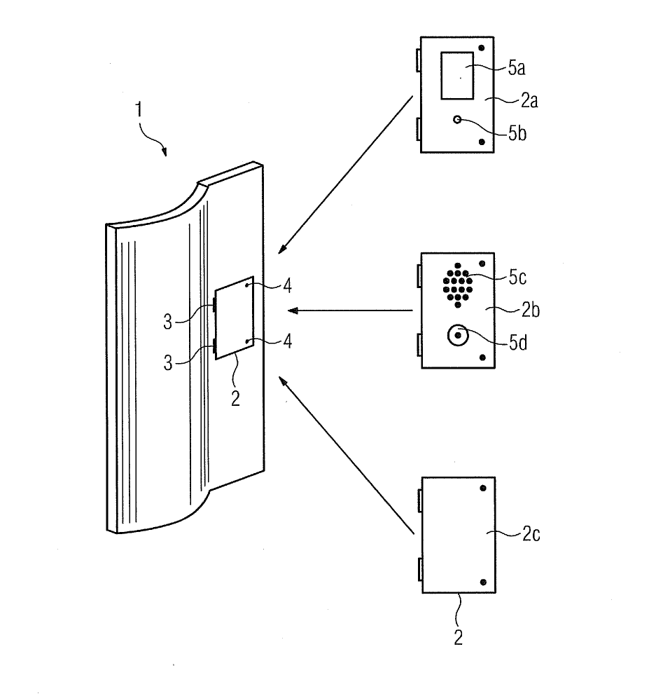

### FIELD OF INVENTION

The invention relates to the interior panel of a vehicle, in particular wall panel of a rail vehicle used in passenger transport, with fastenings and installation openings for mechanical, acoustic and/or electric functional or display elements.

### SUMMARY OF INVENTION

The interior panel of vehicles, in particular the wall panel of rail vehicles for transporting passengers, covers the inside of the car body in order to obtain an esthetic overall appearance and creates a pleasant ambience for the passengers. At the same time, the wall panel is used in order to receive the functional or display elements which are needed for carrying out different requirements. For example, door openers, displays or acoustic devices are installed in the wall panel which is provided for this purpose with openings or apertures in which said elements are accommodated. The openings have been matched individually to the functional and display elements and configured correspondingly. In the event of a malfunction and/or maintenance, the wall parts in which the functional and display elements are located usually have to be removed; it has also already been proposed to configure large wall parts such that they can be pivoted away.

The individual provision of apertures and openings for the functional and display elements and the wiring thereof, and the mounting of the components on the or in the wall parts have proven difficult and costly.

An object of the invention is to configure the interior panel, in particular the wall panel, of a vehicle of the type described at the beginning in such a manner that the fitting of the required functional or display elements is simplified, that the maintenance or repair of defective elements can be carried out rapidly and simply, and that the costs incurred for the mounting and removal and the preparation of the wall panel are as low as possible.

To achieve the object, it is proposed according to the invention that wall panels which are identical in each case are used at the same installation sites of vehicles of the same kind, and an appropriately configured, standardized mounting element which can be placed exchangeably onto the wall panel or can be inserted into the latter is provided for receiving the mechanical, acoustic and/or electric functional or display elements.

The present invention therefore affords two different advantages, namely, firstly, that use can be made of prefabricated, identical wall panels which have already been prepared by the manufacturer to receive various standardized mounting elements and, secondly, that standardized mounting elements are prepared, the mounting elements receiving the mechanical, acoustic and/or electric functional or display elements and being placed in prefabricated form onto the wall panels or being inserted into the latter and being connected thereto. Irrespective of the type, the size and the function of the mechanical, acoustic and/or electric functional or display elements, the wall panel is prepared so as to be universal such that different functional or display elements having the corresponding, prefabricated mounting elements can be placed onto or inserted into wall panels of the same kind for an installation site of the same kind, for example next to the doors of the vehicle. As a result, only the mounting elements according to the invention and not the wall panel elements themselves need to be configured and prepared individually, and therefore a saving on the production costs and on the production and mounting times should be noted from this alone.

In a refinement of the invention, it is provided that the mounting element covers a universal opening provided at the same location in each of the wall panels. By means of this proposal of the invention, it is possible for all of the wall panels for installation sites of the same kind to be able to be provided as early as at the manufacturing stage with universally usable openings at the same location, said openings, in the installed state, being penetrated by the functional or display elements mounted on the mounting element or by the wiring of said elements. If the opening is not used for the installation of functional or display elements, said opening can simply be closed by a cover-like mounting element covering the opening.

If the mounting element is equipped with the functional and/or display elements, functional parts of the elements can penetrate the opening in the wall panel inward such that only those parts of the functional and display elements which are necessary for the operation can be seen from the outside.

In a further refinement of the invention, it is provided that the mounting element can simply be removed for easy accessibility to the mechanical, acoustic and/or electric functional or display elements or can be pivoted into a position permitting good accessibility to the mechanical, acoustic and/or electric functional or display elements. According to the invention, this is carried out in the simplest manner by the mounting element being designed as a door or flap which receives the mechanical, acoustic and/or electric functional or display elements.

According to the invention, in the event of a malfunction or inspection of the functional elements, the flap or the door can be pivoted away such that the rear side of the functional or display elements is exposed. The removal of malfunctions or measurements can thereby be carried out very easily and simply and, furthermore, there is the further advantage that the mounting elements can be fully prepared during manufacturing in order to be connected subsequently to the wall panel in a manner such that they can be pivoted away or released. It is possible in this case for, for example, electric connections to be provided as plug-connections which are easily releasable and re-connectable for replacement purposes and during the mounting of the mounting elements.

The invention provides a favorable solution for installing mechanical, acoustic and/or electric functional or display elements in the interior panel of a vehicle of the type in question. Time and costs can be saved by simplifying the mounting, by premanufacturing components and by standardized preparation both of the wall panel parts and of the mounting elements. In the event of a malfunction, repair is considerably simplified because the elements are easily and rapidly accessible.

### BRIEF DESCRIPTION OF THE DRAWINGS

An exemplary embodiment of the invention is illustrated in the drawing and described below.

### DETAILED DESCRIPTION OF INVENTION

The single FIGURE of the drawing shows an element of a wall panel 1 of a vehicle, which element is configured to be matched to the designated installation site in the car body. The wall panel 1 is fastened to the car body in a customary manner and is only part of the complete interior panel of the vehicle. A mounting element 2 which is configured in the manner of a door and covers an opening in the wall panel 1 (not visible in the drawing) is inserted into the wall panel 1. The mounting element 2 is connected to the wall panel 1 via hinges 3 and is secured by means of screws 4 against unauthorized opening.

As can be seen in the right-hand half of the drawing, the mounting element 2 may be replaced for differently configured, different mounting elements 2a, 2b and 2c into which different mechanical, acoustic and/or electric functional or display elements 5a to 5d are inserted. For example, as shown in the top illustration, a display 5a can be provided together with a door opening button 5b; as illustrated in the middle illustration, an intercom 5c can be provided together with a call button 5d, or else just a simple cover 2c can be provided for closing the opening.

All of the wall panels 1 provided at the same installation site in a vehicle are manufactured identically and provided with a prepared opening which can be covered by one of the mounting elements 2 which are indicated here by way of example. This facilitates the production of the wall panel 1 itself and of the corresponding mounting elements 2 for the functional or display elements 5a to 5d. After the screws 4 have been released, the mounting elements 2 can be opened by pivoting about the hinges 3, in a manner similar to a door, with the functional and display elements 5a to 5d which are installed in the mounting elements 2 being pivoted outward together with the mounting elements 2 such that maintenance or mounting work can easily be carried out.

1. An interior panel of a vehicle, comprising:
fastening units and installation openings for mechanical, acoustic and/or electric functional elements or display elements;
wall panels which are identical in each case at same installation sites of vehicles of a same kind; and
a mounting element for receiving the mechanical, acoustic and/or electric functional elements or display elements.

2. The interior panel as claimed in claim 1, wherein the mounting element is a standardized mounting element which is placed exchangeably onto a wall panel or is inserted into a wall panel.

3. The interior panel as claimed in claim 1, wherein the wall panels are wall panels of a rail vehicle used in passenger transport.

4. The interior panel as claimed in claim 1, wherein the mounting element covers a universal opening provided at a same location in each of the wall panels.

5. The interior panel as claimed in claim 4, wherein at least parts of the mechanical, acoustic and/or electric functional elements or display elements penetrate the universal opening in the wall panel.

6. The interior panel as claimed in claim 1, wherein the mounting element is easily removed for easy accessibility to the mechanical, acoustic and/or electric functional elements or display elements.

7. The interior panel as claimed in claim 1, wherein the mounting element is pivoted into a position permitting good accessibility to the mechanical, acoustic and/or electric functional elements or display elements.

8. The interior panel as claimed in claim 1, wherein the mounting element is designed as a door or flap which receives the mechanical, acoustic and/or electric functional elements or display elements.

9. The interior panel as claimed in claim 1, wherein the mounting element is manufactured from material which is used for the wall panel.
